(19) United States
(12) Patent Application Publication
(10) Pub. No.: US 2026/0212155 A1
(43) Pub. Date: Jul. 23, 2026

(54) MANAGING PROMPTS FOR EDGE AUGMENTED GENERATION

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/035,061

(22) Filed: Jan. 23, 2025

(51) Int. Cl. G06N 3/042; G06N 3/0475

(52) U.S. Cl. CPC G06N 3/042; G06N 3/0475

(57) ABSTRACT

Methods and systems for managing operation of a distributed system are disclosed. A prompt may be submitted to a first inference model that may be hosted by a management system. The management system may obtain responses from edge devices of the distributed system that may be based on locally available data hosted by the edge devices. To do so, a plurality of second prompts may be obtained by the management system and provided to the edge devices for processing using locally hosted inference models. A second prompt may be based on the prompt and characteristics of the edge device and may include a supplemental statement adapted to address an information availability issue impacting the edge device. The responses obtained by the management system and from the edge devices may be used as context data for processing of the prompt to obtain a final response.

### FIELD

Embodiments disclosed herein relate generally to managing a distributed system. More particularly, embodiments disclosed herein relate to systems and methods to manage operation of a distributed system using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2B show data flow diagrams in accordance with an embodiment.

FIG. 2C shows a block diagram illustrating a second distributed system in accordance with an embodiment.

FIG. 2D shows an interaction diagram in accordance with an embodiment.

FIG. 2E shows a data flow diagram in accordance with an embodiment.

FIGS. 3A-3B show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a system that may provide computer-implemented services. The computer-implemented services may be provided using inference models (e.g., a generative trained machine learning model). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate (e.g., prevent) negative outcomes associated with the security events.

A quality (e.g., reliability) of the inferences used to manage the operation of the data processing systems may depend on a quality (e.g., informational content) of the ingest data provided to the (trained) inference models to obtain the inferences. For example, the ingest data may include a prompt (e.g., input from a downstream consumer of the inferences). If the informational content of the prompt is limited and/or ambiguous, then the ingest data to the inference model may be inadequate for generating an inference of expected quality.

To improve a quality of a generated response, a retrieval-augmented generation (RAG) process may be implemented. During the retrieval-augmented generation process, context data (e.g., additional information regarding terms such as words and/or phrases in the prompt) may be retrieved from a trusted knowledge base during a retrieval process. The context data may then be used to increase the informational content of the ingest data provided to the inference models to generate the inference.

However, due to limitations of the retrieval process, the context data may be insufficient to generate expected quality ingest data (e.g., ingest data with adequate informational content). For example, meaningful terms present in the prompt for which additional context is required may not be identified and/or sufficient context data may not be obtained for each identified term in the prompt (e.g., sufficient context data may be stored in a database that may only be accessible to a respective edge device and therefore, may not be accessible to a data processing system hosting an inference model tasked with servicing the prompt).

Thus, to increase a likelihood of providing expected quality ingest data to the inference models, a type of the retrieval process may be performed, at least in part, by a management system (e.g., that hosts the inference model tasked with servicing an initial prompt provided by a downstream consumer) collaborating with respective devices (e.g., edge devices) within a distributed system as part of an edge-augmented generation process until sufficiency criteria for the context data is met. For example, during the edge-augmented generation process, a first RAG process may be initiated by the management system, followed by performance of a second RAG process.

To do so, the management system may obtain second prompts that are based, at least in part, on the initial prompt and characteristics of the edge devices. A second prompt may include a first statement (e.g., based on the initial prompt) and a supplemental statement adapted to address an information availability issue impacting an edge device that prevents the edge device from interpreting at least a portion of the first statement. The supplemental statement may be obtained based on at least one characteristic of the edge device (e.g., a model number, a version number of an instance of an inference model hosted by the edge device, known limitations of information available to the edge device, etc.).

Once obtained, the second prompts may be used during performance of the first RAG process. During the first RAG process, a first response may be obtained from each edge device that may be based on a respective second prompt and context data obtained from a database hosted by the edge device.

The second RAG process may include using the first responses obtained from the edge devices as sufficient context data, the edge devices providing the first responses being regarded as trusted knowledge bases that may be usable to service the initial prompt (e.g., the prompt from the downstream consumer). Therefore, the initial prompt may be ingested by an inference model tasked with servicing the initial prompt along with the first responses as context data. In doing so, a final response may be obtained as output from the inference model, the final response being used to service the initial prompt. Thus, computer-implemented services that are based on the final response may be provided with an increased likelihood of operating in a desirable manner for the downstream consumer.

In an embodiment, a method for managing operation of a system is provided. The method may include: (i) based on a determination that a management system of the distributed system lacks sufficient information regarding edge devices of the distributed system to service a prompt submitted for processing by a first generative trained machine learning model hosted by the management system: (a) obtaining, by the management system, a plurality of second prompts that are based, at least in part, on the prompt and characteristics of the edge devices; (b) initiating, by the management system, first retrieval augmented generation (RAG) processing of the plurality of the second prompts by the edge devices using locally available data hosted by the edge devices as knowledge sources for the first RAG processing to obtain a plurality of first responses from the edge devices; (c) performing, by the management system, second RAG processing of the prompt using the plurality of first responses as the knowledge source for the second RAG processing to obtain a final response; and (d) providing, by the management system, computer-implemented services using the final response.

Obtaining the plurality of second prompts may include: (i) for a first prompt of the plurality of second prompts: (a) obtaining a first statement that is based, at least in part, on the prompt; (b) obtaining a second statement based, at least in part, on at least one characteristic of an edge device of the edge devices; and (c) aggregating the first statement and the second statement to obtain the first prompt.

The second statement may be adapted to address an information availability issue impacting the edge device.

The information availability issue may prevent the edge device from interpreting at least a portion of the first statement.

The at least one characteristic may be a model number or a version number of an instance of a second trained generative machine learning model hosted by the edge device.

The at least one characteristic may be a lack of a type of information that is locally available to the edge device for use during the first RAG processing.

Obtaining the second statement may include: (i) obtaining an identify of the edge device; and (ii) filtering a repository of supplemental statements based on the identity of the edge device to obtain at least the second statement.

Obtaining the second statement may include: (i) identifying at least one term that is present in the first statement; and (ii) filtering a repository of supplemental statements based on the at least one term to obtain at least the second statement.

The repository may be managed using a dashboard that facilitates differentiation of the edge devices and corresponding supplemental statements for the edge devices, the dashboard providing for integration of new supplemental statement into the repository based on user input.

The plurality of second prompts may include: (i) a first prompt that comprises a primary statement and a supplementary statement customized to a first future recipient of the first prompt; and (ii) a second prompt that comprises the primary statement and that does not comprise any supplementary statements for a second future recipient of the second prompt.

A non-transitory media may include instructions that when executed by a processor cause the computer-implemented method to be performed.

A data processing system may include the non-transitory media and a processor, and may perform the computer-implemented method when the computer instructions are executed by the processor.

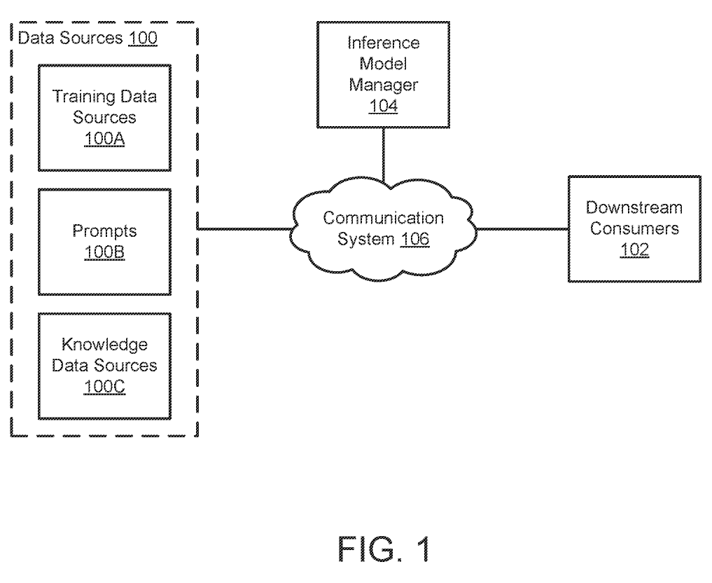

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include a prompt based on a behavior (e.g., an undesired behavior, a security threat, etc.) of a data processing system. The prompt may include, for example, information regarding programs being executed by components of a data processing system, and the inference model may be trained to provide a desired response, based on the ingest data, that indicates a root cause for the behavior of the data processing system, a remediation process to be performed to address the behavior, a diagnosis process for the behavior, and/or any other information. To manage the behavior, the inference may be provided to a downstream process during which operation of the data processing system may be updated in a manner that mitigates an undesired outcome of the undesired behavior.

However, the responses obtained from the (trained) inference models may not be reliable for managing the operation of the data processing systems if informational content of the ingest data used during inferencing is inadequate. For example, terms (e.g., words and/or phrases) included in the prompt may be ambiguous and/or may have special meaning (e.g., a term may have different meaning to an operator of the inference models than a meaning based on its dictionary definition). Therefore, to increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt.

To increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt. The context data may include a set of chunks of data (e.g., documents, data entries in a database, multimedia files, etc.) hosted by a knowledge data source.

To obtain expected quality (e.g., adequate) ingest data, the prompt may be provided to a data pipeline. The data pipeline may include a retrieval process, during which terms in the prompt are identified, and context data for the identified terms is obtained from the knowledge data source. For example, the retrieval process may use methods to (i) identify terms present in the prompt that may require context data, (ii) identify portions of context data from a trusted data source based on the identified terms, (iii) rank the identified portions of context data (e.g., based on relevancy to the terms), and/or (iv) select a number of the ranked identified portions of context data for use as the context data, and/or perform any other actions.

However, due to limitations of these methods, a quality of at least a portion of the context data used for inferencing may be undesirable for obtaining a response usable to effectively manage operation of a data processing system. For example, the chunks of data retrieved from the knowledge data source may include inconsistent information (e.g., contradicting information between at least two chunks of the context data.). Consequently, if the inconsistent information is used as context data, a quality of the inferences and subsequent computer-implemented services provided using the inferences may be negatively impacted. For example, the inferences may be inaccurate, computational resources may be wasted attempting to resolve the inconsistencies, harmful actions may be performed based on the inferences, etc.

In general, embodiments disclosed herein may provide methods, systems, and/or devices for managing operation of data processing systems using inference models in a manner that is more likely to result in desirable management outcomes. To do so, prompts for processing by the inference models may be preprocessed using an iterative retrieval process that continues to retrieve context data until the context data meets sufficiency criteria. For example, the sufficiency criteria may specify a minimum level of content of the context data with respect to ontology definitions (e.g., defined by an operator of the inference models). The ontology definitions may include a list of ontology terms for which context data is to be retrieved when instances of the ontology terms are present in the prompt. The retrieval process may be performed iteratively until sufficient context data has been retrieved for each instance of an ontology term present in the prompt.

By doing so, the context data obtained during prompt preprocessing may be more likely to be sufficient for providing adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

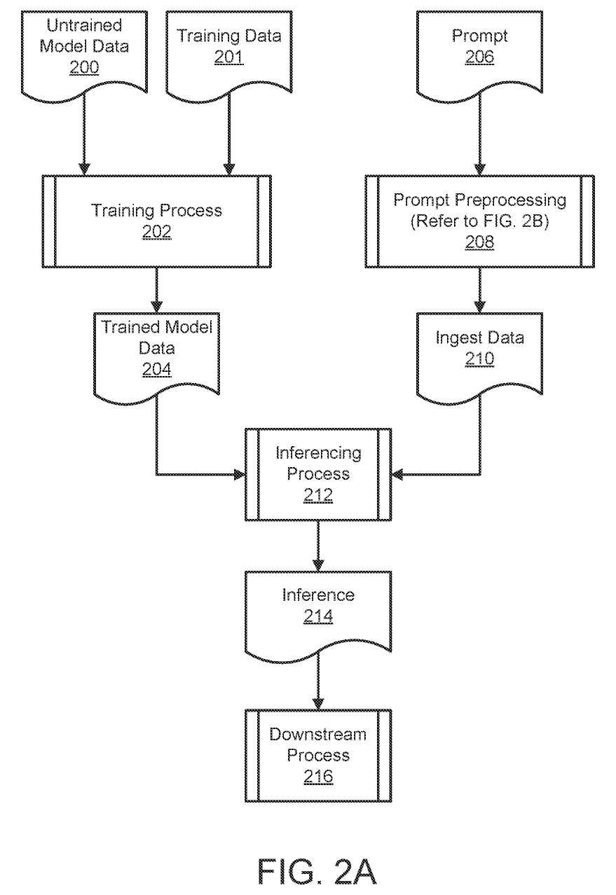

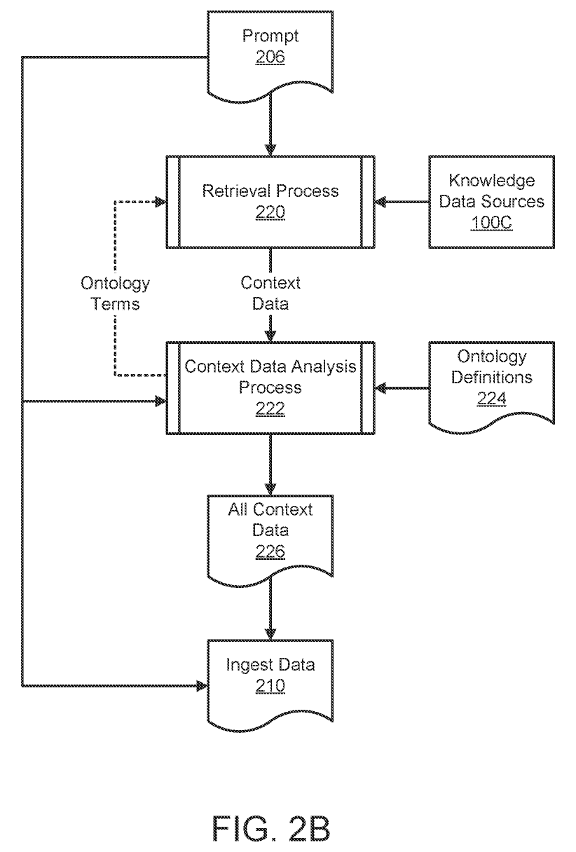

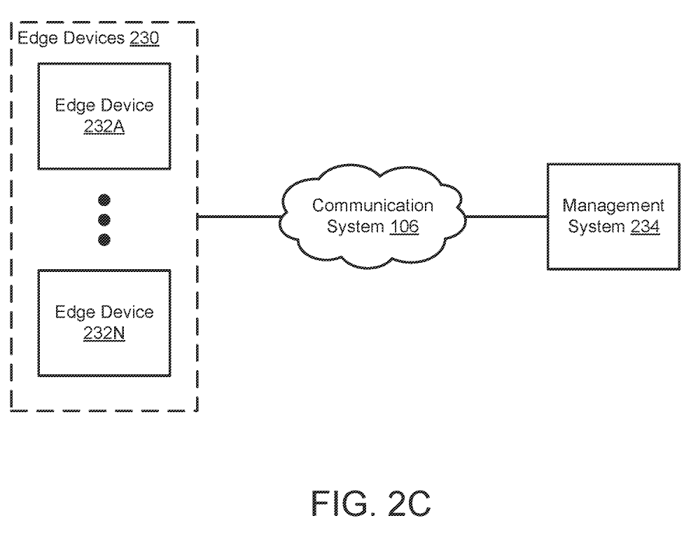

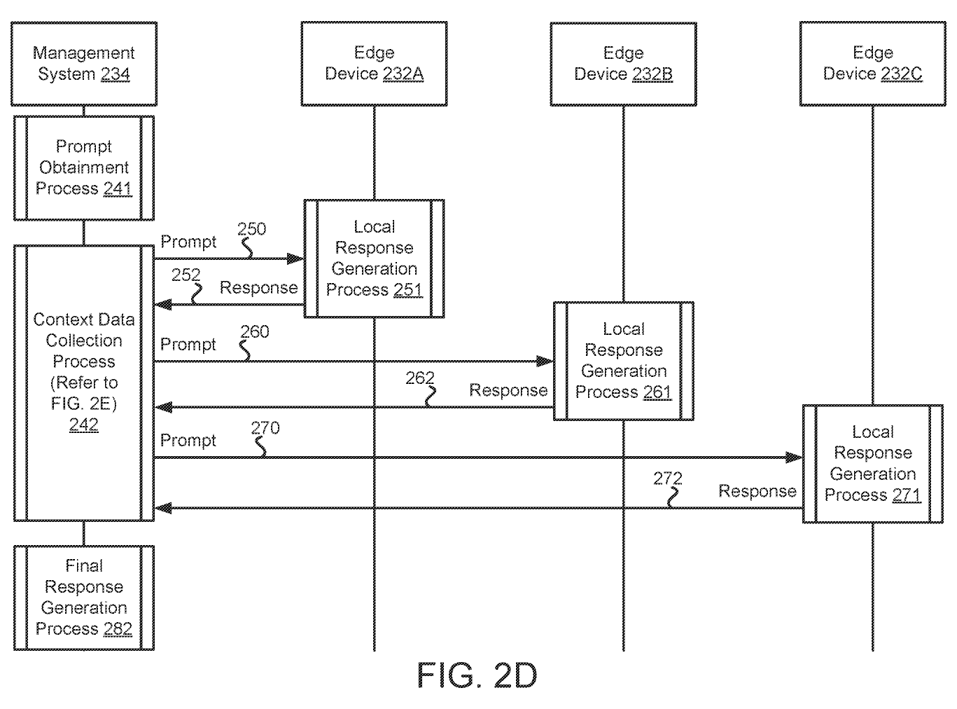

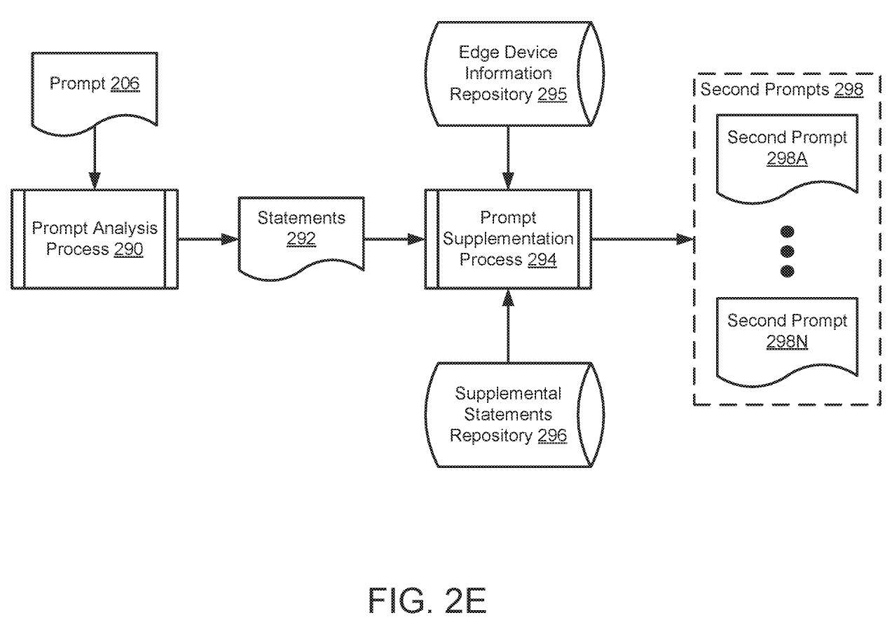

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms, and may undergo preprocessing to obtain sufficient context data for generating adequate ingest data. Refer to the discussion of FIGS. 2A-2B for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a first retrieval process for the prompt to obtain context data, (iii) analyze the context data based on ontology definitions to identify instances of ontology terms present in the prompt for which the context data does not meet sufficiency criteria, (iv) perform additional retrieval processes for the identified instances of ontology terms to obtain additional context data that meets the sufficiency criteria, and/or (v) obtain ingest data based on the prompt and/or the context data obtained during any of the performed retrieval processes. Refer to the discussion of FIG. 2B for an example of an ontology-based iterative retrieval process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

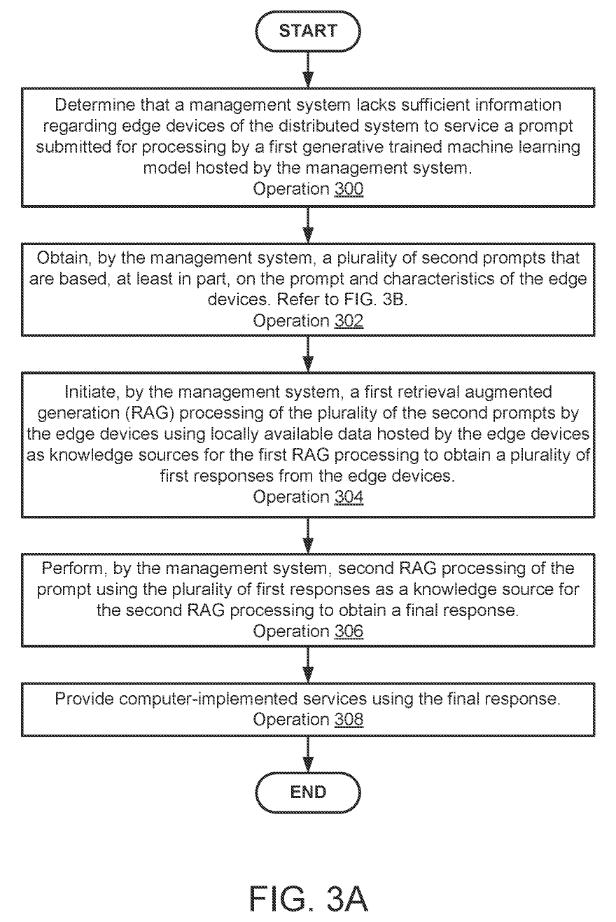

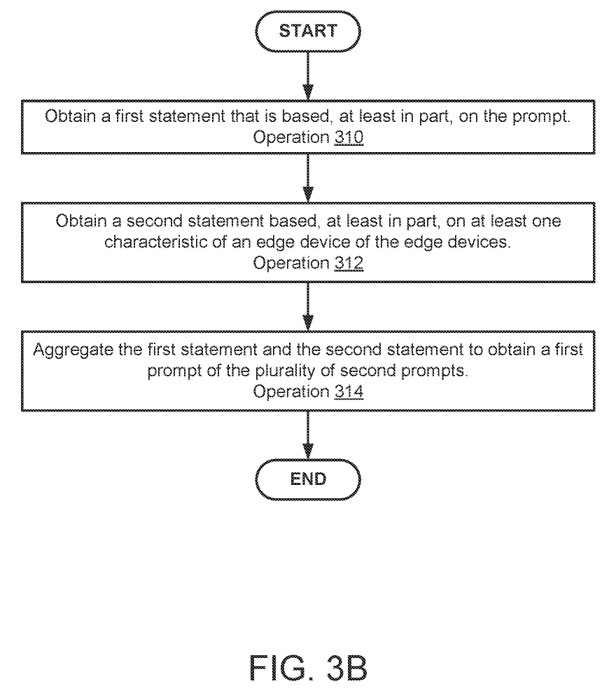

When providing their functionality, any of data sources 100, downstream consumers 102, inference model manager 104, and/or components thereof may perform all, or a portion of the actions and methods illustrated in FIGS. 2A-3B.

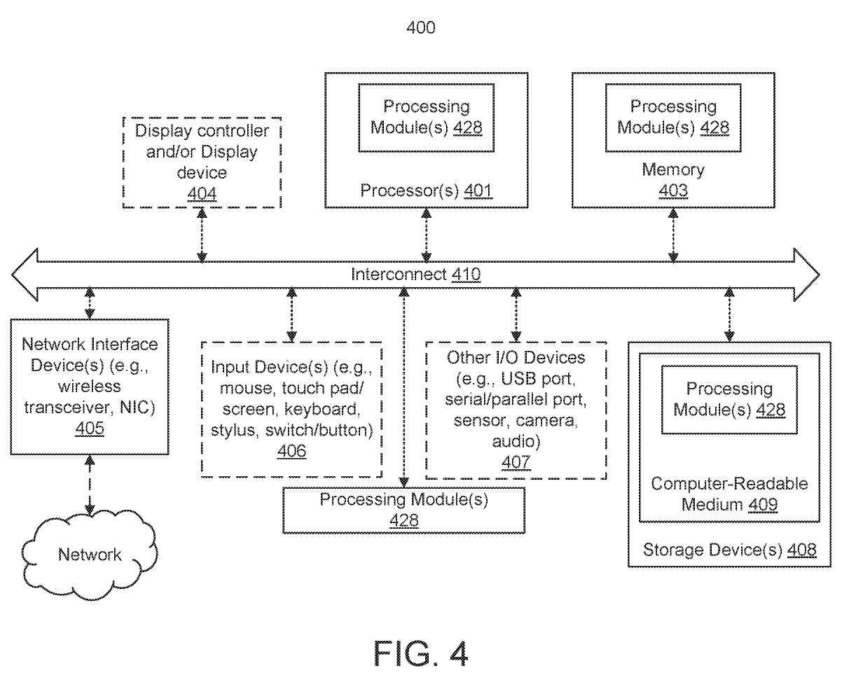

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for ontology terms present in prompt 206 may be obtained and ingest data 210 may be generated based on prompt 206 and/or the context data. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate informational content), ontology terms included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system.

To obtain the context data for prompt 206, retrieval process 220 may be performed. Retrieval process 220 may include any type of process(es) wherein information (e.g., terms) present in a prompt is identified, and additional information is retrieved from a data source based on the identified information. For example, retrieval process 220 may implement information retrieval methods used during type of retrieval-augmented generation process. During retrieval process 220, a prompt (e.g., prompt 206) may be obtained and used to generate a query (e.g., a keyword search query). The query may include, for example, search terms, search parameters, and/or other information. The query may then be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms).

During a first performance of retrieval process 220, an original query may be generated based on prompt 206 (e.g., during the first performance of retrieval process 220, ontology terms may not be obtained from context data analysis process 222 as indicated by a respective arrow drawn in dashing). The original query may be derived from terms (e.g., words and/or phrases) present in prompt 206. The original query may be serviced using a deterministic process (e.g., using a trained deterministic inference model and/or any process that returns the same results for repeated servicing of the original query). For example, the original query may be used to identify portions of data responsive to the search terms and using the search parameters and/or instructions included in the original query from knowledge data sources 100C.

The identified portions of data responsive to the original query may then be ranked for relevance using a relevance ranking algorithm. Some number (e.g., best hits) of the ranked portions of data may then be selected for use as the context data. However, due to limitations of the relevance ranking algorithm and/or selection criteria, the selected context data may lack context for some terms present in the prompt such as those defined by ontology definitions 224. Therefore, to address these limitations of retrieval process 220, context data analysis process 222 may be performed.

During context data analysis process 222, context data obtained from retrieval process 220 may be analyzed using ontology definitions 224. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas.

During context data analysis process 222, first context data obtained from the first retrieval process may be evaluated to determine whether the first context data meets sufficiency criteria. The sufficiency criteria may specify a minimum level of content of context data with respect to ontology definitions 224. For example, instances of ontology terms specified by ontology definitions 224 that are present in prompt 206 may be identified, and levels of content of the first context related to each instance of the ontology terms may be identified. The levels of content may be compared to the minimum level of content to identify any instances of ontology terms for which the first context data does not meet the sufficiency criteria.

For example, the minimum level of content may specify, for each ontology term of ontology definitions 224 present in prompt 206, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of ontology terms present in prompt 206 that are required to satisfy the minimum level of content, and/or an increased number of terms (e.g., other ontology terms defined by ontology definitions 224, other terms not defined by ontology definitions 224) beyond the ontology terms present in prompt 206 that are required to satisfy the minimum level of content. Any instances of ontology terms identified as present in prompt 206 that are not associated with context data satisfying at least the minimum level of content may be identified during context data analysis process 222.

If the first context data meets the sufficiency criteria for all ontology terms present in prompt 206, then the first context data may be included in all context data 226. However, if at least one instance of an ontology term may be identified for which the first context data does not meet the sufficiency criteria, then at least a portion of the first context data may be included in all context data 226 (e.g., the portion of the first context data that meet the sufficiency criteria).

In a first example, the at least one instance of the ontology term (e.g., shown as “ontology terms” in FIG. 2B) having insufficient context data may be provided to retrieval process 220 to initiate a second (iteration of) retrieval process 220 (e.g., ontology terms for which sufficient context data has been retrieved may not be included in the ontology terms provided to retrieval process 220.

In a second example, the ontology terms provided to retrieval process 220 may include all ontology terms identified in prompt 206, and each of the ontology terms may be tagged (e.g., via updating metadata) to indicate whether sufficient context data has been retrieved for each of the ontology terms. For example, the ontology term associated with the identified at least one instance may be tagged as being associated with insufficient context data, while other ontology terms may be tagged as being associated with sufficient context data.

Note that the arrow indicating the ontology terms are provided to retrieval process 220 is drawn in dashing to indicate that under some conditions the ontology terms may not be provided to retrieval process 220 (e.g., during a first iteration of retrieval process 220 and/or during subsequent iterations of retrieval process 220 when retrieved context data meets the sufficiency criteria for all ontology terms present in prompt 206).

During the second retrieval process, a revised query may be derived using the ontology terms obtained from context data analysis process 222. For example, the revised query may only include ontology terms that are tagged as associated with insufficient context data. The revised query may include a reduced number of ontology terms specified by the ontology definitions when compared to a number of ontology terms specified by the original query. The reduced number of ontology terms may include the ontology term (e.g., for which the at least one instance of the ontology term was identified), and may exclude a second ontology term of ontology definitions 224 for which an instance of the second ontology term is present in prompt 206 and for which the first context data meets the sufficiency criteria (e.g., the second ontology term having been included in the original query).

Consider a security example where a prompt, “Program A is being executed by component C of data processing system D, using resources Q, and is accessing file F,” is provided to retrieval process 220. During the first retrieval process, “A,” “C,” “D,” and “F” may include ontology terms specified by ontology definitions 224. The ontology terms may be identified and used to obtain the original query. Therefore, the original query may include 4 ontology terms specified by ontology definitions 224.

During the first retrieval process, knowledge data sources 100C may return sufficient context data for “A” “C”, and “D”, but not “F”. Therefore, during context data analysis process 222, “F” may be identified as not being associated with at least the minimum level of content specified by the sufficiency criteria. Therefore, context data analysis process 222 may provide a data package including “F” (and excluding “A”, “C”, and “D”, for which sufficient context data has already been obtained) to retrieval process 220, and a second retrieval process may be performed. The second retrieval process may use a revised query that includes 1 ontology term specified by ontology definitions 224 (e.g., “F”).

Returning to the second retrieval process, the revised query may be used to retrieve second context data from knowledge data sources 100C. By using the revised query, the search algorithm used during retrieval process 220 may be more likely to rank and select sufficient context data for the ontology terms included in the revised query compared to when using the original query.

The second context data may be provided to context data analysis process 222, and a determination may be made regarding whether the second context data meets the sufficiency criteria. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of retrieval process 220 and/or context data analysis process 222 may be performed until all context data 226 meets the sufficiency criteria for each instance of ontology terms present in prompt 206.

All context data 226 may include context data retrieved during any number of iterations of retrieval process 220. All context data 226 may be used, in part, to obtain ingest data 210. For example, ingest data 210 may include all context data 226 (e.g., the first context data and/or the second context data) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIG. 2B, a quality of ingest data to inference models may be improved using context data obtained via an iterative retrieval process. The iterative retrieval process may be more likely to produce sufficient context data for instances of ontology terms present in prompts submitted for processing by the inference models. By doing so, inferences obtained based on the ingest data may be more likely to be reliable for managing operation of data processing systems, and the data processing systems may be more likely provide desired computer-implemented services.

While specific context data analysis and retrieval processes are shown and discussed with regard to FIG. 2B, it will be appreciated that other processes regarding context data collection may be used without departing from embodiments discussed herein.

Turning to FIG. 2C, a block diagram illustrating a second distributed system in accordance with an embodiment is shown. The system shown in FIG. 2C may provide computer-implemented services similar to the first distributed system shown and discussed with regard to FIG. 1. It will be appreciated, however, that in the discussion of FIG. 1 an inference model tasked with servicing the prompt may be able to access a trusted knowledge base that may include sufficient context data. The inference model may then ingest this sufficient context data to output a final response that when used has an increased likelihood of initiating desired operation of data processing systems within the first distributed system.

In contrast, the following discussion of FIG. 2C may regard a second distributed system in which the inference model tasked with servicing the prompt may be unable to access a trusted knowledge base that may include the sufficient context data. In such cases, the previously discussed edge-augmented generation process may be facilitated by the second distributed system (e.g., as shown in FIG. 2C) and/or components thereof to provide the computer-implemented services.

As previously discussed in FIG. 1, the computer-implemented services may include any type and quantity of computer-implemented services. The computer-implemented services may be provided by data processing systems to consumers of the computer-implemented services based on an operation of the second distributed system of which the data processing systems may be a part. To provide the computer-implemented services as desired by a downstream consumer of the services, operation of the data processing systems (e.g., operation of the second distributed system) may be managed. The operation may be managed using artificial intelligence. For example, (trained) inference models may be used to assess, predict, and/or otherwise manage occurrences of events that may negatively impact provisioning of the computer-implemented services as desired by providing useful final responses. Also, as previously discussed, to increase a likelihood of generating reliable responses during inferencing, a retrieval-augmented generation (RAG) process may be implemented to improve informational content of the ingest data to the inference models. To do so, the prompt may undergo preprocessing, during which context data may be obtained for terms present in the prompt.

However, trusted knowledge bases with a high likelihood of storing desirable context data for servicing the prompt may not be accessible to the inference model tasked with the servicing of the prompt. Such trusted knowledge bases may instead be subject to limited accessibility. One of such trusted knowledge bases may, for example, only be accessible by an individual edge device.

In general, embodiments disclosed herein may provide methods, systems, and/or devices for managing operation of a distributed system using a distributed generative inference model pipeline. The distributed generative inference model pipeline may facilitate acquisitions and use of information stored in disparate locations across the system shown in FIG. 2C. The collected information may, for example, enable expected quality (e.g., adequate) ingest data (for generative models) to be obtained and used by management system 234.

The generative inference model pipeline may include multiple instances of inference models hosted by different components of the system. The different components of the system may have access to different local information.

Some of the instances of the inference models may use the local information as a RAG data sources, while other instances of the inference models may use remote instances of inference models as RAG data sources. For example, management system 234 may use edge devices 230 as RAG data sources, while each of edge devices 230 may use the local information available to them as the RAG data sources.

When a request for management system 234 is obtained, the request may be treated as an initial prompt. To service the initial prompt, management system 234 may generate and distribute prompts to any of edge devices 230 in an attempt to obtain responses usable as context data for the initial prompt. The initial prompt and resulting context data may be input to the inference model hosted by management system 234 to obtain a final response. The final response may be used to service the request, and/or provide other services for a downstream process/consumer during/for which operation of a data processing system may be updated.

To obtain the responses, second prompts may be provided to edge devices with access to trusted knowledge bases where required context data may be stored. Each respective trusted knowledge bases may include information (e.g., local information) that may be inaccessible to management system. Each second prompt may include at least a first statement that may be based on the initial prompt. For example, the first statement may include a textual query relayed to each edge device by management system 234 based on the initial prompt.

However, at least a portion of the edge devices may be impacted by an information availably issue that may prevent the portion of edge device from interpreting at least a portion of the first statement. For example, consider a scenario in which the initial prompt and the corresponding first statement are obtained by management system 234 regarding whether a firewall is implemented for edge devices 230. While a first portion of edge devices 230 may be able to interpret the term “firewall” and perform a retrieval process to obtain desired information, a second portion of edge devices 230 may not be able to interpret the term “firewall”. For example, the second portion of edge devices 230 may include a type of device that may utilize an alternative implementation of a network security system (e.g., a network management application, sandboxing, etc.), and therefore may not be able to provide a desired response if unable to interpret the second prompt.

To improve a likelihood that desired responses are obtained from the edge devices, a second statement (e.g., a supplemental statement) may be obtained based, at least in part, on at least one characteristic of an edge device. The characteristic may include, for example, a model number of a version number of an instance of a second trained inference model hosted by a respective edge device, a (known) lack of a type of information that is locally available to the edge device, and/or any other information.

Returning to the previous example in which the second portion of edge devices 230 may not be able to interpret the term “firewall”, management system 234 may identify the second portion of edge devices 230 based on, for example, a set of device identifiers, instances of inference models used by the second portion of edge devices 230, and/or any other characteristics. By doing so, the second statement may be obtained that may provide supplemental information (e.g., additional context information) to the second portion of edge devices 230 that may, for example, define a firewall in a manner that may be interpretable by the second portion of edge devices 230 (e.g., “Application XYZ is a type of firewall. Do you have application XYZ installed?”).

To obtain the second statement, a repository of supplemental statements may be filtered and/or searched using an identity of an edge device, a term present in the first statement, and/or any other information usable to identify the second statement. Once obtained, the second statement (e.g., a modifying statement, a supplemental statement, etc.) and the first statement (e.g., a textual query and/or statement based on the initial prompt) may be aggregated to obtain the second prompt.

Once obtained, the second prompts may be provided to the respective edge devices that may subsequently utilize respectively hosted inference models to ingest a copy of the second prompts along with retrieved context data from the local information. In doing so, first responses may be output by these inference models that may then be provided to, for example, the management system.

To obtain the final response, the first responses (e.g., used as context data) may be used as ingest data, along with the initial prompt (e.g., provided by a downstream consumer), for the inference model hosted by the management system. Such ingestion may result in the inference model hosted by the management system outputting the final response. The final response may then be used to initiate update of the system, or perform other processes (e.g., which may depend on the request originally obtained by the system).

By doing so, operation of the distributed system may be managed without requiring a centralized source of information. Accordingly, data collection processes such as telemetry data collection may not need to be performed by management system 234 to manage operation of the distributed system. Accordingly, the computational overhead for data collection, processing, and storage may be avoided. In many example cases, most collected information may not ever be used thereby rendering the computational expenditures in collecting and aggregating such information to be of little to no value to the operation of the system. Thus, the disclosed system may reduce computational overhead for managing operation of the system.

To provide the above-mentioned functionality, the second distributed system of FIG. 2C may include edge devices 230, management system 234, and communication system 106. The second distributed system, any components thereof, and/or any other types of devices or components not shown in FIG. 2C may perform all, or a portion of the computer-implemented services independently and/or cooperatively. Each of these components is discussed below with the exception of communication system 106 due to being previously discussed with regard to FIG. 1.

Management system 234 may generally manage the operation of the system of FIG. 2C. For example, management system 234 may receive requests, instructions, etc. to be performed with respect to components of the system. To service the requests, instructions, etc., management system 234 may use the distributed generative inference model pipeline, as discussed above.

Management system 234 may host and/or otherwise utilize a repository of supplemental statements that may include any number and/or type of information usable to supplement and/or modify an initial prompt to obtain a second prompt to be provided to a portion of edge devices 230. To facilitate use of the repository, management system 234 may, for example, host a dashboard (e.g., a software application) that may enable differentiation of the edge devices and corresponding supplemental statement for the edge devices. The dashboard may also provide for integration of new supplemental statements into the repository based on user input. For example, a user of management system 234 may select a predefined supplemental statement to be included in a second prompt, define new supplemental statements (e.g., for a select portion of edge devices, terms present in a prompt, etc.), and/or perform any other actions via the dashboard hosted by management system 234.

Edge devices 230 may provide any number and type of computer-implemented services and be managed by management system 234. During such management, edge devices 230 may participate in the distributed generative inference model pipeline. For example, each of these edge devices may include access to a local database that (i) is inaccessible to management system 234, and (ii) may include stored data regarding its host that may be beneficial to contribute to (directly and/or indirectly) context data for servicing the initial prompt. The local database may include information such as, for example, logs of operation of the system, issues impacting the respective edge devices, locally collected and/or generated information (e.g., sensor measurements, derived information from the sensor measurements, etc.), and/or any other type of local information obtained and/or generated by the edge device (and/or information provided to it by other devices).

For additional information regarding operation of inference models, refer back to FIG. 2A. For additional information regarding distributed generative inference model pipelines and operation thereof as part of the system shown in FIG. 2C, refer to FIGS. 2D-3B.

When providing their functionality, any of edge devices 230, management system 234, and/or components thereof may perform all, or a portion of the actions and methods illustrated in FIGS. 2A-3B.

Any of edge devices 230 and management system 234 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 2C may be operably connected to each other (and/or components not illustrated) with communication system 106. Communication system 106 may facilitate communications between the components of FIG. 2C as discussed with regard to FIG. 1. As previously discussed, communication system 106 may include one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 2C as including a limited number of specific components, a system in accordance with an embodiment may include fewer, additional, and/or different components than those illustrated therein.

To further clarify embodiments disclosed herein, an interaction diagram in accordance with an embodiment is shown in FIG. 2D. This interaction diagram may illustrate how data may be obtained and used within the systems of FIGS. 1 and 2C.

In the interaction diagram, processes performed by and interactions between components of a system in accordance with an embodiment are shown. In the diagrams, components of the system are illustrated using a first set of shapes (e.g., 234, 232A, etc.), located towards the top of FIG. 2D. Lines descend from these shapes. Processes performed by the components of the system are illustrated using a second set of shapes (e.g., 242, 251, etc.) superimposed over these lines. Interactions (e.g., communication, data transmissions, etc.) between the components of the system are illustrated using a third set of shapes (e.g., 250, 262, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 250 may occur prior to the interaction labeled as 252. However, it will be appreciated that the processes and interactions may be performed in different orders, any may be omitted, and other processes or interactions may be performed without departing from embodiments disclosed herein.

Turning to FIG. 2D, an interaction diagram in accordance with an embodiment is shown. The interaction diagram may illustrate processes and interactions that may occur during management of a distributed system. For example, such management may be performed, at least in part, by a management system (e.g., 234).

To manage the distributed system, a distributed generative inference model pipeline may be used as discussed above with regard to FIG. 2C. In doing so, an edge-augmented generation process may be performed. During this edge-augmented generation process, (i) a prompt obtainment process may be performed (e.g., 241), (ii) a context data collection process may be performed (e.g., 242), (iii) a final response generation process may be performed (e.g., 282), and/or (iv) other processes may be performed, not to be limited by embodiment discussed herein.

During prompt obtainment process 241, (i) a prompt may be submitted for processing by a first generative trained machine learning model (e.g., that may be hosted by management system 234), (ii) a determination may be made regarding whether there is access to information that may be relevant to the prompt, or whether there is a lack of sufficient information regarding edge devices of the distributed system to service the prompt (e.g., serviced by management system 234).

Assume that (i) the first generative trained machine learning model is hosted by management system 234 and (ii) the prompt may be obtained as an outcome of any number of processes/operations. For example, the prompt may be (i) provided by a user via a user interface (UI), (ii) generated by software hosted by management system 234 as a result of management system 234’s operation, and/or (iii) any other type and/or quantity of processes/operations not to be limited by embodiments discussed herein.

For example, such a prompt may include (e.g., assuming that the prompt is based on the previously mentioned user interaction via a UI) a string of text such as “How did the overheating policies in my devices affect system performance last summer?” The determination that there is the lack of sufficient information to service the prompt may be based on, for example, management system 234 not having access to local and respective databases of various edge devices whose respective hardware components’ operating states (e.g., during “last summer”) the prompt may, for example, indicate as being required telemetry information of the edge devices.

Based on this determination, context data collection process 242 may be performed to obtain context data for attempting to increase a quality of an output from the first generative trained machine learning model that is based on the prompt. During context data collection process 242, (i) a plurality of second prompts may be obtained, (ii) a copy of at least one second prompt of the plurality of second prompts may be provided to one of the edge devices, (iii) it may be indicated to the one of the edge devices that the at least one second prompt is to be processed to obtain one first response (that may, in some cases, be of a plurality of first responses) and that the one first response is to be provided to the management system, (iv) obtaining either the plurality of the first responses, or in cases where there may be only one edge device, the one first response, and/or (v) other processes may be performed, not to be limited by embodiments discussed herein.

It will be appreciated that the examples discussed below are discussed based on an assumption that there is more than one edge device whose telemetry data is indicated by the prompt as being desirable (and/or required) to service the prompt.

To obtain the plurality of second prompts, the first generative trained machine learning model of management system 234 (and/or another inference model of management system 234) may generate an output to be used as the plurality of second prompts based on (i) the prompt, (ii) the type and/or quantity of the plurality of edge devices, and/or other information not to be limited by embodiments discussed herein.

The second prompts may be based, at least in part, on the initial prompt and characteristics of the edge devices. Each second prompt may include a first statement based on the initial prompt (e.g., obtained during prompt obtainment process 241). Additionally, management system 234 may identify a portion of edge devices 230 (e.g., edge device 232B-C) that may be impacted by an information availability issue and a second portion of edge devices 230 (e.g., edge device 232A) that may not be impacted by an information availability issue. For the second portion of edge devices, management system 234 may provide the second prompt that includes the first statement. For the first portion of edge devices (e.g., that are impacted by the information availability issue), management system 234 may obtain a second statement (e.g., a supplemental statement) to be provided along with the first statement to address the information availability issue.

To obtain the second statement, management system 234 may identify at least one characteristic of the edge device (e.g., 232A) that may include, for example, a model number of an instance of a trained inference model hosted by edge device 232A, a lack of a type of information locally available to edge device 232A, and/or any other information. Once identified, a repository of supplemental statements may be filtered and/or searched using an identity of an edge device, a term present in the first statement, and/or any other information usable to identify the second statement. Once obtained, the second statement (e.g., a modifying statement, a supplemental statement, etc.) and the first statement (e.g., a textual query and/or statement based on the initial prompt) may be aggregated to obtain the second prompt. Refer to FIG. 2E for additional details regarding obtaining a second prompt that may include a supplemental statement based on a characteristic of an edge device.

Copies of the at least one second prompt may thus be provided to each of the various edge devices (e.g., 232A-232C). For example, during context data collection process 242, interactions 250-272 may be performed where such copies are provided, and such first responses are obtained. Furthermore, by selectively providing second prompts that include supplemental statements, a quality computer-implemented services (e.g., computational cost for inferencing) provided using the second prompts may be improved (e.g., by reducing input tokens used by a second prompt).

For example, at interaction 250, a prompt (e.g., a copy of the at least one second prompt) may be provided to edge device 232A by management system 234. The prompt may include a first statement (e.g., based on the prompt) and the supplemental statement identified to be applied based on characteristics of edge device 232A. In doing so, it may be indicated to edge device 232A that this copy of (and/or an otherwise derivative of) the at least one second prompt requires processing to obtain the one first response. The copy of a second prompt may be generated and provided to edge device 232A by (i) transmission via a message, (ii) storing in a storage with subsequent retrieval by edge device 232A, and/or (iii) via other processes not to be limited by embodiments discussed herein. By providing the second prompt to edge device 232A, edge device 232A may be capable of providing the one first response to management system 234 as discussed below.

To provide the one first response, edge device 232A may perform local response generation process 251. During local response generation process 251, (i) the copy of the at least one second prompt may be obtained as shown with interaction 250, (ii) the obtained second prompt may be used as input for an inference model locally hosted by edge device 232A while local storage (e.g., a local database) of edge device 232A may be accessed to retrieve relevant information that may also be used as input for the inference model along with the obtained second prompt, (iii) the one first response may be obtained as output from the inference model based on the input, and (iv) the one first response may be provided to management system 234.

For example, the retrieved information may be telemetry data specifying an operating state of edge device 232A, this telemetry data being inaccessible to management system 234. For example, such telemetry data may include ongoing operations performed by respective components of edge device 232A along with a respective temperature for each of the components. This telemetry data may therefore be used as input for, along with the at least one second prompt, processing by the inference model hosted by edge device 232A. Based on this input, an output may be obtained and used as the one first response. For example, the one first response may be a string of text (e.g., similar to the prompt and/or the second prompt) such as “edge device 232A’s processor is overheating.”

At interaction 252, a response (e.g., the one first response) may be provided to management system 234 by edge device 232A. In doing so, management system 234 may obtain additional context data to be ingested with the (initial) prompt to attempt at increasing a quality of inferences made (e.g., output) to service the prompt, the additional context data including the plurality of first responses.

It will be appreciated that interactions 260-262 and 270-272 are the copies of the at least one second prompt and corresponding first responses respectively sent to, and obtained from, other edge devices, edge device 232B and edge device 232C. For example, upon each obtaining a copy of the at least one second prompt via interactions 260 and 270, local response generation process 261 and local response generation process 271 may be respectively performed by edge device 232B and edge device 232C. However, based on these processes being similar to that performed by edge device 232A (e.g., local response generation process 251), these processes may differ in that each edge device may utilize their own locally hosted inference models and databases to obtain respective first responses that are relevant to the respective edge devices. Additionally, it will be appreciated that these local databases and/or inference models may be inaccessible to management system 234, as previously discussed.

By performing these processes, the edge devices may collectively provide the plurality of first responses to management system 234, concluding performance of context data collection process 242. Once sufficient context data is obtained by performing context data collection process 242, final response generation process 282 may be performed.

During final response generation process 282, (i) the plurality of the first responses may be used as ingest, along with the original prompt provided by the user, for the first generative trained machine learning model (e.g., the inference model hosted by management system 234), (ii) an output may be obtained from the inference model, the output being the final response to service the prompt, and (iii) the providing of computer-implemented services based on the final response may be initiated.

For example, the final response may include a string of text such as “edge device 232A is overheating” (assuming that the other edge devices had first responses that indicated respective temperatures and operation that, for simplicity, are considered ideal). Therefore, services initiated by the final response may include increasing fan rotations per minute to attempt to increase cooling of edge device 232A.

Turning to FIG. 2E, a third data flow diagram in accordance with an embodiment is shown. The third data flow diagram may illustrate data used in and data processing performed when obtaining second prompts to provide to edge devices based on characteristics of the edge devices.

To obtain the second prompts, prompt analysis process 290 may be performed. During prompt analysis process 290, an initial prompt submitted for processing by a first inference model hosted by management system 234 may be analyzed to obtain at least one first statement based on the initial prompt (e.g., prompt 206). For example, to do so, prompt 206 may be interpreted (e.g., via natural language processing), a portion of context data may be obtained, a number and/or type of information desired from edge devices (e.g., due to inaccessibility by management system 234) may be identified, and/or any other actions may be performed. By doing so, at least one first statement may be obtained based on the initial prompt.

The at least one first statement (e.g., statements 292) may include a request for the information desired to be obtained from the edge devices. Statement 292 may include a same textual statement (e.g., query, request, etc.) included in prompt 206, a statement relevant to prompt 206, and/or any other information. For example, consider a scenario in which prompt 206 provided by a network administrator indicates a request regarding compliance of edge devices 230 (e.g., “Are all devices compliant with group security policies?”). As a result of prompt analysis process 290, statements 292 may be obtained (e.g., based on information regarding the group security policies) that may indicate requests to obtain local information (e.g., quality of passwords, status of virtual private network, status of firewall, etc.) from each (e.g., or a selected portion) of edge devices 230.

Because a portion of edge devices 230 may be impacted by information availability issues, the portion of edge devices may be unable to interpret at least a portion of statements 292. To improve a likelihood that the edge devices may provide desired responses, prompt supplementation process 294 may be performed. During prompt supplementation process 294, characteristics of the edge devices may be identified, supplemental statements may be obtained, and the at least one first statements may be aggregated with the supplemental statements to obtain the second prompts. For example, to identify the characteristics of the edge devices, management system 343 may request information regarding the characteristics prior and/or during obtaining of the second prompts. The information regarding the edge devices may be stored in edge device information repository 295. The information may include, for example, an identity of an edge device, a model number of a version number of an instance of a trained generative machine learning model hosted by the edge device, limitations to information that may be locally available for the edge device, and/or any other information regarding characteristics of the edge device.

To obtain the supplemental statements based on the characteristics of the edge devices, supplemental statements repository 296 may be filtered (e.g., and/or searched) based on the identity of the edge device, a term present in statements 292 (e.g., a term that may not be interpretable by an edge device), and/or any other information. Supplemental statements repository 296 may include any number and/or type of information that may be adapted to address an information availability issue impacting an edge device that prevents the edge device from interpreting at least a portion of the first statement. Once obtained, the supplemental statements may be aggregated with statements 292 to obtain second prompts 298.

Second prompts 298 may include similar and/or different statements to be provided to edge devices 230 by management system 234. For example, a first second prompt (e.g., 298A) of second prompts 298 may include at least one statement of statements 292 and a supplementary statement customized to a first edge device (e.g., 230A). Second prompt 298B may include at least one statement of statements 292 and a supplementary statement (e.g., that may be the same or different from the first supplementary statement). Second prompt 298C may include at least one statement of statements 292 and may not include any supplementary statement (e.g., based on a determination that the corresponding edge device does not require supplementary information as discussed in FIG. 2D).

For example, returning to the previous example in which a prompt is obtained regarding whether devices are compliant with group security policies, it may be identified based on a model number of an instance of an inference model used by an edge device (e.g., 232A) that edge device 232A may lack information usable to obtain a response to a statement of statements 292 regarding a quality of passwords used to secure edge device 232A. A supplemental statement may be identified and provided as part second prompt 298A to edge device 232A that may provide supplemental context information (e.g., that criteria for a strong password includes a minimum number of characters, symbols, casings, etc.) usable by edge device 232A to evaluate the quality of the passwords. By doing so, edges devices may provide responses of a higher quality and/or desirability for use by the management system when obtaining a final response (e.g., by performing a second RAG process of the prompt using the responses).

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2B and FIG. 2E, the block diagram shown in FIG. 2C, and the interaction diagram shown in FIG. 2D, a quality of ingest data to inference models may be improved using localized responses from edge devices as context data obtained via an edge-augmented generation process. The edge-augmented generation process may be more likely to produce sufficient context data for instances where prompts submitted for processing by the inference models are with regard to edge devices whose (e.g., private) respective databases may not be available to a management system hosting the inference models. By doing so, inferences obtained based on the ingest data may be more likely to be reliable for managing operation of such edge devices and/or other devices of the distributed system, and the distributed system may be more likely to provide desired computer-implemented services.

Turning to FIG. 3A, a first flow diagram illustrating a method in accordance with an embodiment is shown. The flow diagram may illustrate various operations performed while managing operation of a system.

At operation 300, a management system of the distributed system may be determined to be lacking sufficient information regarding edge devices of the distributed system to service a prompt submitted for processing by a first generative trained machine learning model hosted by the management system. The determination may be made (assuming that available context data has been collected based on the prompt), by (i) obtaining sufficiency criteria for the context data, (ii) comparing the collected context data to the sufficiency criteria (e.g., as discussed with regard to FIGS. 1-2B), and (iii) identifying, based on the comparison, whether the context data is meeting the criteria.

Additionally, for example, should the prompt indicate a need for information regarding devices within the distributed system (e.g., edge devices) whose operations, configurations, and history are inaccessible to the management system, the determination may (in some cases) be made automatically (e.g., regarding whether there is access to relevant information required to service the prompt). This may be due to a decreased likelihood of the ingest data being adequate without consideration of such information regarding an indicated device (e.g., the inadequacy resulting from a lack of sufficient information regarding edge devices of the distributed system to service the prompt). Therefore, to increase a likelihood of the inferences being reliable for use in managing the operation of the system, the consideration of such information regarding the devices within the distributed system may be required to obtain adequate ingest data.

At operation 302, a plurality of second prompts may be obtained by the management system. This plurality of second prompts may be obtained by generating an output that may be used as the plurality of second prompts. Such an output may be obtained from an inference model based on input provided to the inference model. Such input may include the prompt as well as, for example, data specifying the type and/or quantity of the any number of the edge devices, and/or other information not to be limited by embodiments discussed herein.

To obtain a second prompt of the plurality of second prompts, management system 234 may (i) obtain a first statement based, at least in part, on the prompt, (ii) obtain a second statement, based at least in part, on at least one characteristic of an edge device, (iii) aggregate the first statement and the second statement to obtain the second prompt of the plurality of second prompts. Refer to FIG. 3B for additional details regarding obtaining a second prompt of the plurality of second prompts.

Once obtained, a copy of the at least one second prompt may be provided to each of the plurality of edge devices (e.g., at least a selected portion of the edge devices). It will be appreciated, however, that although provided (in this case) to each edge device of the plurality of edge devices, a copy of (and/or an otherwise derivative of) the at least one second prompt may be provided to any portion of the plurality of edge devices, wherein such provisioning of the at least one second prompt is not to be limited by embodiments discussed herein.

At operation 304, first retrieval augmented generation (RAG) processing of the plurality of the second prompts may be initiated by the management system by the edge devices using locally available data hosted by the edge devices as knowledge sources for the first RAG processing to obtain a plurality of first responses from the edge devices. The first RAG process may be initiated by (i) sending a copy of the at least one second prompt of the plurality of second prompts to one of the edge devices, and (ii) indicating to the one of the edge devices that the at least one second prompt is to be processed to obtain one first response of the plurality of first responses and that the one first response of the plurality of first responses is to be provided to the management system. These first responses may be provided by the edge devices using, for example, their own local inference models with access to the trusted knowledge bases (e.g., “knowledge sources” that may include information regarding a respective one of the edge devices) that were discussed as being inaccessible to the management system. For example, at least one of the knowledge sources may include a portion of telemetry information for a corresponding one of the edge devices, the portion of the telemetry information being required information for servicing of the (initial) prompt, and the portion of the telemetry information not being available for use by the management system.

Additionally, it will be appreciated that a one of the first responses may include (e.g., be implemented with) a textual response that is based, at least in part, on a portion of the telemetry information, the telemetry information being, as indicated above, locally stored on the one of the edge devices and not available to the management system. For example, this textual response may therefore be distinguishable from the portion of the telemetry information, and the telemetry information may not be recoverable based on just the textual response.

By depending on the edge devices to obtain the first responses based on the second prompts and provide the first responses back to the management system, the management system may be able to use the first responses as adequate context data in place of data that, in this case, was inaccessible to the management system. Therefore, such context data may be used with the (initial) prompt to obtain ingest data for the management system’s inference model to output a final response as discussed below.

At operation 306, second RAG processing of the prompt may be performed by the management system using the plurality of first responses as a knowledge source for the second RAG processing to obtain a final response. To perform the second RAG processing of the prompt, (i) the prompt and (ii) the plurality of first responses as context for the prompt may be submitted as input to the first generative trained machine learning model to obtain the final response as output from the first generative trained machine learning model.

At operation 308, computer-implemented services are provided by the management system using the final response. These services may be provided by (i) identifying, using the final response, a state of one of the edge devices, and (ii) identifying at least one modification for the one of the edge devices based on the state, and (iii) updating operation of the one of the edge devices based on the at least one modification.

The at least one modification may include at least one selected from a list of modifications. This list may include, for example, (i) modifying a configuration of a first software component and/or a first hardware component, (ii) disabling a second software component and/or a second hardware component, and/or (iii) installing a third software component.

The method may end following operation 308.

Thus, as illustrated above, embodiments disclosed herein may provide systems and methods for managing operation of a distributed system based on context data obtained via an edge-augmented retrieval generation process. Such management may be facilitated by input to an inference model (e.g., a large language learning model) that results in an increased likelihood of reliable inferencing by the inference models. As a result, the distributed system may be more likely to be updated reliably (e.g., appropriately, timely), and the computer-implemented services provided by the distributed system may be more likely to be desired computer-implemented services.

Turning to FIG. 3B, a second flow diagram illustrating a method in accordance with an embodiment is shown. The flow diagram may illustrate various operations performed while obtaining a first prompt of the plurality of second prompts.

At operation 310, a first statement may be obtained based, at least in part, on the prompt. The first statement may be obtained by: (i) interpreting the prompt using natural language processing, (ii) retrieving context data (e.g., from knowledge data sources) based on the prompt, (iii) identifying, using the prompt and context data, more nuanced prompts (e.g., more informed statements, questions, requests, etc.), (iv) generating a copy of the prompt, and/or via any other processes.

At operation 312, a second statement may be obtained based, at least in part, on at least one characteristic of an edge device of the edge devices. The second statement may be obtained by: (i) identifying an identify of the edge device, (ii) identifying a term present in the first statement, (iii) performing a lookup using a dashboard used to manage a supplemental statement repository to identify at least one second statement mapped to the identity and/or the term, and/or performing any other actions.

At operation 314, the first statement and the second statement may be aggregated to obtain the first prompt of the plurality of second prompts. The first statement and the second statement may be aggregated by: (i) providing the second statement as a pre-prompt (e.g., establishing a predefined context) to the first statement, (ii) modifying the first statement to adhere to a predefined schema and/or meaning indicated by the second statement, and/or via any other processes.

The method may end following operation 314.

Using the method shown in FIG. 3B, supplemental statements may be obtained to address an information availability issue impacting an edge device. By doing so, the edge device may be more likely to interpret a prompt and subsequently provide a desired response for use in providing computer-implemented services by the management system.

Thus, as illustrated above, embodiments disclosed herein may provide systems and methods for managing edge device inference generation to obtain inferences used to manage operations of data processing systems. For example, by incorporating each response (e.g., each inference) from respective edge devices, each of the responses being based on a query and/or supplemented to address an information availability issue, a resulting response that is based on each of the responses may have an increased likelihood of being reliable. As a result of this increased reliability, computer-implemented services provided by the data processing systems may be more likely to be desired computer-implemented services when incorporating such inferences from the respective edge devices.

Any of the components illustrated in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
based on a determination that a management system of the distributed system lacks sufficient information regarding edge devices of the distributed system to service a prompt submitted for processing by a first generative trained machine learning model hosted by the management system:
obtaining, by the management system, a plurality of second prompts that are based, at least in part, on the prompt and characteristics of the edge devices;
initiating, by the management system, first retrieval augmented generation (RAG) processing of the plurality of the second prompts by the edge devices using locally available data hosted by the edge devices as knowledge sources for the first RAG processing to obtain a plurality of first responses from the edge devices;
performing, by the management system, second RAG processing of the prompt using the plurality of first responses as the knowledge source for the second RAG processing to obtain a final response; and
providing, by the management system, computer-implemented services using the final response.

2. The method of claim 1, wherein obtaining the plurality of second prompts comprises:
for a first prompt of the plurality of second prompts:
obtaining a first statement that is based, at least in part, on the prompt;
obtaining a second statement based, at least in part, on at least one characteristic of an edge device of the edge devices; and
aggregating the first statement and the second statement to obtain the first prompt.

3. The method of claim 2, wherein the second statement is adapted to address an information availability issue impacting the edge device.

4. The method of claim 3, wherein the information availability issue prevents the edge device from interpreting at least a portion of the first statement.

5. The method of claim 2, wherein the at least one characteristic is a model number or a version number of an instance of a second trained generative machine learning model hosted by the edge device.

6. The method of claim 2, wherein the at least one characteristic is a lack of a type of information that is locally available to the edge device for use during the first RAG processing.

7. The method of claim 2, wherein obtaining the second statement comprises:
obtaining an identity of the edge device; and
filtering a repository of supplemental statements based on the identity of the edge device to obtain at least the second statement.

8. The method of claim 2, wherein obtaining the second statement comprises:
identifying at least one term that is present in the first statement; and
filtering a repository of supplemental statements based on the at least one term to obtain at least the second statement.

9. The method of claim 8, wherein the repository is managed using a dashboard that facilitates differentiation of the edge devices and corresponding supplemental statements for the edge devices, the dashboard providing for integration of new supplemental statement into the repository based on user input.

10. The method of claim 1, wherein the plurality of second prompts comprises:
a first prompt that comprises a primary statement and a supplementary statement customized to a first future recipient of the first prompt; and
a second prompt that comprises the primary statement and that does not comprise any supplementary statements for a second future recipient of the second prompt.

11. A non-transitory machine-readable medium having instructions stored therein, which when executed by a processor, cause the processor to perform operations for managing operation of a distributed system, the operations comprising:
based on a determination that a management system of the distributed system lacks sufficient information regarding edge devices of the distributed system to service a prompt submitted for processing by a first generative trained machine learning model hosted by the management system:
obtaining, by the management system, a plurality of second prompts that are based, at least in part, on the prompt and characteristics of the edge devices;
initiating, by the management system, first retrieval augmented generation (RAG) processing of the plurality of the second prompts by the edge devices using locally available data hosted by the edge devices as knowledge sources for the first RAG processing to obtain a plurality of first responses from the edge devices;
performing, by the management system, second RAG processing of the prompt using the plurality of first responses as the knowledge source for the second RAG processing to obtain a final response; and
providing, by the management system, computer-implemented services using the final response.

12. The non-transitory machine-readable medium of claim 11, wherein obtaining the plurality of second prompts comprises:
for a first prompt of the plurality of second prompts:
obtaining a first statement that is based, at least in part, on the prompt;
obtaining a second statement based, at least in part, on at least one characteristic of an edge device of the edge devices; and
aggregating the first statement and the second statement to obtain the first prompt.

13. The non-transitory machine-readable medium of claim 12, wherein the second statement is adapted to address an information availability issue impacting the edge device.

14. The non-transitory machine-readable medium of claim 13, wherein the information availability issue prevents the edge device from interpreting at least a portion of the first statement.

15. The non-transitory machine-readable medium of claim 12, wherein the at least one characteristic is a model number or a version number of an instance of a second trained generative machine learning model hosted by the edge device.

16. A data processing system, comprising:
a processor; and
a memory coupled to the processor to store instructions, which when executed by the processor, cause operations for managing operation of a distributed system to be performed, the operations comprising:
based on a determination that a management system of the distributed system lacks sufficient information regarding edge devices of the distributed system to service a prompt submitted for processing by a first generative trained machine learning model hosted by the management system:
obtaining, by the management system, a plurality of second prompts that are based, at least in part, on the prompt and characteristics of the edge devices;
initiating, by the management system, first retrieval augmented generation (RAG) processing of the plurality of the second prompts by the edge devices using locally available data hosted by the edge devices as knowledge sources for the first RAG processing to obtain a plurality of first responses from the edge devices;
performing, by the management system, second RAG processing of the prompt using the plurality of first responses as the knowledge source for the second RAG processing to obtain a final response; and
providing, by the management system, computer-implemented services using the final response.

17. The data processing system of claim 16, wherein obtaining the plurality of second prompts comprises:
for a first prompt of the plurality of second prompts:
obtaining a first statement that is based, at least in part, on the prompt;
obtaining a second statement based, at least in part, on at least one characteristic of an edge device of the edge devices; and
aggregating the first statement and the second statement to obtain the first prompt.

18. The data processing system of claim 17, wherein the second statement is adapted to address an information availability issue impacting the edge device.

19. The data processing system of claim 18, wherein the information availability issue prevents the edge device from interpreting at least a portion of the first statement.

20. The data processing system of claim 17, wherein the at least one characteristic is a model number or a version number of an instance of a second trained generative machine learning model hosted by the edge device.
